(19) United States
(12) Patent Application Publication
(10) Pub. No.: US 2024/0072362 A1
(43) Pub. Date: Feb. 29, 2024

(54) SOLDERLESS BATTERY PACK

(71) Applicant: Zhejiang Fengli Technology Development Co., Ltd, Zhejiang (CN)

(72) Inventors: Yifan LU, Huzhou, Zhejiang (CN); Qiang GONG, Huzhou, Zhejiang (CN); Bin DUAN, Huzhou, Zhejiang (CN); Xuehao SHEN, Huzhou, Zhejiang (CN); Qijun SHI, Huzhou, Zhejiang (CN)

(21) Appl. No.: 18/003,831

(22) PCT Filed: Jun. 20, 2022
(86) PCT No.: PCT/CN2022/099780

§ 371 Date: Dec. 29, 2022

(30) Foreign Application Priority Data
Jun. 8, 2022 (CN) 202210645974.X

(51) Int. Cl. H01M 50/264; H01M 50/213; H01M 50/224; H01M 50/291; H01M 50/298; H01M 50/503; H01M 50/505; H01M 50/519; H01M 50/522

(52) U.S. Cl. CPC H01M 50/264; H01M 50/213; H01M 50/224; H01M 50/291; H01M 50/298; H01M 50/503; H01M 50/505; H01M 50/519; H01M 50/522

(57) ABSTRACT

A solderless battery pack is provided that includes a battery port, a protective plate, an upper end plate, a lower end plate, cell groups and a cell locking mechanism. The cell groups are arranged between the upper end plate and the lower end plate and include a cell installation bracket, cells and a PCB busbar. The cell locking mechanism includes a metal upper pressing plate, a metal lower pressing plate and a fastening long bolt that passes through the metal upper pressing plate, the metal lower pressing plate, the upper end plate, the lower end plate and the cell groups.

### TECHNICAL FIELD

The present disclosure relates to the technical field of lithium batteries, in particular to a solderless battery pack.

### BACKGROUND

The following battery is usually used as lithium ion battery: ternary lithium or lithium iron phosphate is used as the positive material, graphite is used as the negative material, the positive and negative electrodes are separated by a spacer, and lithium ion is conducted by electrolyte. Lithium battery cells have a variety of structures, such as cylindrical cells, square aluminum casing cells and soft packed cells. The cylindrical cells need to be assembled in series and parallel to reach the required voltage and battery capacity.

### SUMMARY

### Technical Problem to be Solved

Conventional lithium battery cylindrical cells mainly use welding structures such as resistance welding, aluminum wire welding and laser welding, so it is difficult to disassemble and repair after the lithium battery is formed, and the surface of the welded cell will be damaged after disassembly, which is not conducive to after-sales maintenance and echelon utilization.

### Technical Solutions

The object of the present disclosure is to solve the problems in the background part, and provide a solderless battery pack, which can complete the production, assembly, disassembly and maintenance with only a screwdriver, eliminate the common welding process of lithium battery assembly, and bring great convenience to production and maintenance.

The above technical object of the present disclosure is achieved through the following technical solutions.

A solderless battery pack comprises a battery port, a protective plate, an upper end plate, a lower end plate, cell groups and a cell locking mechanism. The cell groups are installed between the upper end plate and the lower end plate. The cell group comprises a cell installation bracket, cells and a PCB busbar. The cell locking mechanism comprises a metal upper pressing plate, a metal lower pressing plate and a fastening long bolt. The fastening long bolt passes through the metal upper pressing plate, the metal lower pressing plate, the upper end plate, the lower end plate and the cell groups.

Preferably, the cell installation bracket comprises a cell installation surface, a PCB installation surface, a cell connecting hole and a locking through hole. The cell installation surface is provided with cell slots, support columns, hooks and buckles, the hooks and the buckles have the same quantity and are disposed oppositely, and a cell slot snap wall is provided around the cell slot. The PCB installation surface is provided with PCB axial positioning stages, dual function positioning columns and dual function positioning holes, the dual function positioning columns and the dual function positioning holes have the same quantity and are disposed oppositely, and a contour of the PCB installation surface is provided with an edge-wrapping strip. The cell installation surface is provided with positioning columns and positioning cylinders, and the positioning columns and the positioning cylinders have the same quantity and are disposed oppositely.

Preferably, a top part of the hook is provided with a guide angle.

Preferably, the guide angle is 20°˜45°.

Since the top part of the hook is provided with the guide angle, the hook can automatically deform outward and finally clamp in place only by directly pressing the upper bracket. There is a gap between the hook and the buckle, so that after the cell surface is bonded with the cell groove surface on the bracket, the deformation of the hook during the clamping process can be automatically restored under the elastic force, and the hook clamps in place with the buckle. After the modules are assembled, the hook and buckle structure can be manually or mechanically grasped by the edge of the upper bracket during the installation process to lift the whole module and stack the modules in the next step, without worrying about the falling and scattering of modules in the conveying process.

Preferably, the PCB busbar comprises a base plate and a cell connecting spring piece. The base plate is provided with a spring piece installation hole, a board positioning hole and a bolt through hole. The cell is fastened by an external force of the bolt, and the bolt through hole is configured to let the fastening bolt pass through. The base plate is printed with a cell connecting circuit and a cell voltage acquisition circuit. The cell voltage acquisition circuit the has the functions of collecting an voltage and maintaining the cell. The cell connecting spring piece is installed in the spring piece installation hole, the cell connecting circuit is connected with the spring piece installation hole, two sides of the base plate abut against the PCB axial positioning stage, and a central plane of the base plate in a thickness direction aligns with a central plane of the PCB installation group.

The board positioning holes are circular positioning holes and waist shaped positioning holes that appear in pairs, which can cooperate with the positioning columns on the cell bracket to play a good role of positioning. Moreover, in the design, the extending direction of the waist shaped holes coincides with the connecting direction of the waist shaped holes and the circular holes, so that the PCB and the cell bracket can be smoothly assembled even if there is a large manufacturing error in the circular holes and the waist shaped holes, and at the same time, it can be avoided that inaccurate vacancy causes the bow of PCB after assembled, and when the whole solderless module is pressed and assembled, the bowed PCB is crushed or the size of the whole lithium battery pack becomes larger.

Preferably, the base plate is provided with a lead out electrode, which is connected with the cell connection circuit. The lead out electrode comprises a busbar and a post. The post is in the form of a stud or a nut. Busbar locating buckles for connecting with the base plate are provided on two sides of the busbar. The post is in the form of a stud or a nut or the like, which can be locked with threads in cooperation with the OT terminal of the battery pack, so as to avoid manual welding in the process of battery pack assembly, maintenance and disassembly, and simplify maintenance and replacement. The positioning buckles in cooperation with a relief hole on the PCB play a role of accurate and reliable positioning.

Preferably, the base plate is provided thereon with a sampling connector, which is connected with the cell voltage acquisition circuit.

Preferably, a solder pad is provided at the spring piece installation hole, and the cell connecting spring piece is fixed at the spring piece installation hole by welding with the solder pad.

Preferably, the cell connecting spring piece is stamped from a metal disc as a whole, and comprises: a circular solder pad and a contact elastic piece. The circular solder pad and the contact elastic piece are connected through a stamping section, the stamping section is a stamping concave structure and comprises a concave wall and a stamping flat boss. Two ends of the concave wall are respectively connected with the circular solder pad and the stamping flat boss, and the stamping flat boss is arranged in parallel with the circular solder pad. A base part of the contact elastic piece is connected with the stamping flat boss, and an angle is formed between the contact elastic piece and the stamping flat boss, and the stamping flat boss aligns with a central plane of the base plate in a thickness direction.

The design of the concave wall structure is conducive to the laying down and positioning of the spring piece without considering the placement direction of the spring piece, thereby reducing the placement requirements while ensuring a certain positioning accuracy, which is conducive to improving production capacity and large-scale production.

Preferably, the contact elastic piece is a triangle, and a bottom edge of the triangle is connected with the stamping flat boss.

Preferably, an inverted arch stiffener is provided at the connection part between the contact elastic piece and the stamping flat boss. It can enhance the elastic force of the spring piece and ensure the reliable contact between the spring piece and the cell; at the same time, it is conducive to the recovery of the spring piece from the deformed state and maintaining its elasticity when the battery pack is disassembled, and is conducive to repeated use of the spring piece.

Preferably, a top part of the contact elastic piece is provided with an arc contact. By providing the arc contact on a top part of the spring piece, the contact area with the cylindrical cell is increased, the contact resistance with the cell is reduced, the heating when the battery is charged and discharged is reduced, and the overcurrent capacity of the battery pack is improved. Moreover, when the spring piece is compressed, the arc can slide smoothly on the cell to avoid being stuck, avoid scratching, protect the surface of the cell and the plating layer of the spring piece, and thus prevent surface oxidation.

Preferably, a plurality of contact elastic pieces are provided on the circumference. The contact elastic pieces comprise an up-warping group and a down-warping group, and the contact elastic pieces in the up-warping group and the down-warping group are spaced and uniformly distributed along the circumferential direction. The contact elastic pieces are distributed at an equal angle on the circumference. Compared with traditional single elastic piece or spring contact, the contact area is larger, and the contact is more stable and balanced. When it is subject to the pressing forces from the upper and lower cells, the upper and lower forces are balanced, thereby reducing the risk of the spring piece peeling off from the tin solder pad.

Preferably, the cell group comprises a cell installation group and a PCB pack. The cell installation group comprises two cell installation brackets and the cells. The two cell installation brackets in the cell installation group are arranged in a central symmetry, and their cell installation surfaces are opposite to each other, the cell is installed between the two cell installation surfaces, and two ends of the cell clamp in the cell slot. The PCB installation group comprises two cell installation brackets and the PCB busbar, the two cell installation brackets in the PCB installation group are symmetrically arranged in the center, and their PCB installation surfaces are opposite to each other. The PCB busbar is arranged between the two PCB installation surfaces and is positioned through the dual function positioning column and the dual function positioning hole. The fastening long bolt locks the cell installation group and PCB installation group via the locking through hole.

The two cell installation brackets have exactly the same structure, and the lower bracket is obtained after the upper bracket is rotated 180 degrees. When in use, the cell is inserted into the bracket, and then another bracket that is exactly the same is prepared. After positioning by the long positioning cylinder and the long positioning column, the brackets are pressed until the cell is completely attached to the ground of the cell slot to form a cell module. Since the structures of the two cell installation brackets are exactly the same, only one set of mold is needed, which reduces the types of materials, and there is no need to distinguish during installation, which is convenient for production management.

Preferably, the quantity of cells between the two adjacent locking through holes is less than 6.

Preferably, a gap is provided between the hook and the buckle of the two cell installation brackets in the cell installation group. The hook and buckle connection replaces the threaded connection, which realizes the tool free installation and tool free disassembly of the cell, and facilitates production and after-sales service. The gap after the final assembly of the hook and buckle structure makes the connection of the upper bracket, the cell and the lower bracket have no pre-tightening force, which can ensure that the solderless module can be naturally and completely flat when pressed, so that the cells can be tightly pressed in the bracket. If the threaded connection is used, after locked by threads, the inner surface of the bracket groove at the edge will be pressed against the cell at the edge of the module. Due to the leverage effect, a middle part of the bracket is easy to deform and arch upward, and thus the cells in the middle cannot be tightly pressed, resulting in unreliable contact between the solderless spring piece and the cells. Finally, the internal resistance of the whole pack will be affected.

Preferably, a wire trough is provided on a side face of the cell installation bracket, and a long stop strip and a short stop strip are provided outside the wire trough. When the cell installation bracket is rotated and installed, the dislocation will be formed, which can effectively clamp the harness. The design of stop strips avoids the use of the harness tie, simplifies the structure, reduces the cost, and improves the production efficiency.

Preferably, the cell installation bracket is provided with a sampling port relief slot.

Preferably, the locking through hole passes through the positioning column and the positioning cylinder.

Preferably, a thickness of the metal upper pressing plate and the metal lower pressing plate is 1.5˜3 mm.

Preferably, the metal upper pressing plate is integrated with the upper end plate; the metal lower pressing plate is integrated with the lower end plate.

### Beneficial Effect

In sum, the solderless battery pack according to the present disclosure can complete production, assembly, disassembly and maintenance with only a screwdriver, eliminating the common welding processes (laser welding, resistance welding, tin welding, ultrasonic welding, etc.) of lithium battery assembly, and bringing great convenience to production and maintenance.

### BRIEF DESCRIPTION OF DRAWINGS

FIG. 1 is a schematic view of the assembling of a battery pack of the present disclosure;

FIG. 2 is a schematic view of the structure of an installation surface of a cell of the present disclosure;

FIG. 3 is a schematic view of the structure of a PCB installation surface of the present disclosure;

FIG. 4 is a schematic view of the structure of a cell installation group of the present disclosure;

FIG. 5 is a schematic view of the structure of a PCB installation group of the present disclosure;

FIG. 6 is a schematic view of the structure of a PCB busbar of the present disclosure;

FIG. 7 is a schematic view of the structure of a cell connecting spring piece of the present disclosure; and

FIG. 8 is a schematic view of the installation of a cell connecting spring piece and a PCB busbar of the present disclosure.

### DETAILED DESCRIPTION

The following specific embodiments are only an explanation of the present disclosure, not a limitation of the present disclosure. Those skilled in the art can make modifications to the embodiments as needed without making creative contributions after reading the specification, and they are protected by the patent law as long as they are within the scope of the claims of the present disclosure.

The present disclosure will be described in detail below by embodiments in conjunction with the accompanying drawings.

### First Embodiment

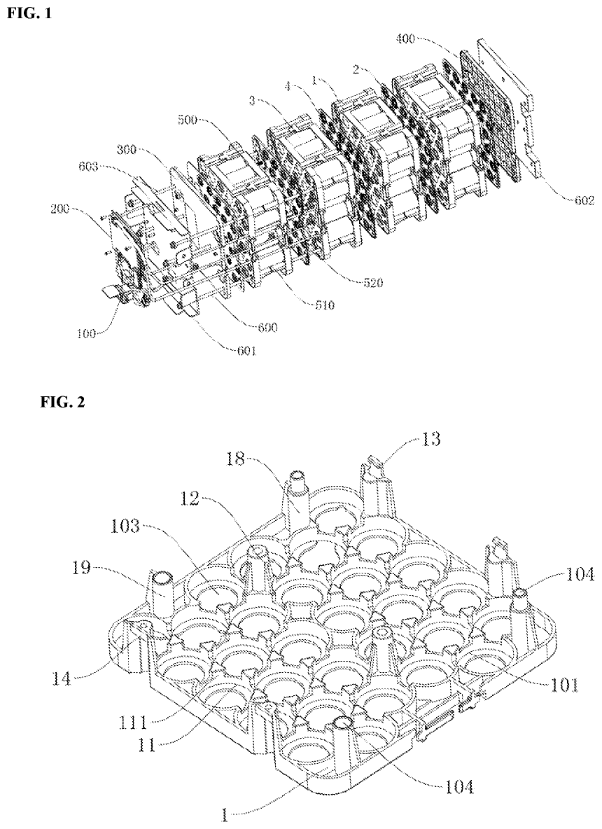

As shown in FIGS. 1 to 8, a solderless battery pack comprises: a battery port 100, a protective plate 200, an upper end plate 300, a lower end plate 400, cell groups 500 and a cell locking mechanism 600. The cell groups 500 are installed between the upper end plate 300 and the lower end plate 400. The cell group 500 comprises a cell installation bracket 1, cells 3 and a PCB busbar 4. The cell locking mechanism 600 comprises a metal upper pressing plate 601, a metal lower pressing plate 602 and a fastening long bolt 603. The fastening long bolt 603 passes through the metal upper pressing plate 601, the metal lower pressing plate 602, the upper end plate 300, the lower end plate 400 and the cell groups 500. The thickness of the metal upper pressing plate 601 and the metal lower pressing plate 602 is 1.5˜3 mm.

As shown in FIGS. 2 and 3, the cell installation bracket 1 comprises a cell installation surface 101, a PCB installation surface 102, a cell connecting hole 103 and a locking through hole 104. The cell installation surface 101 is provided with cell slots 11, support columns 12, hooks 13 and buckles 14. The hooks 13 and the buckles 14 have the same quantity and are disposed oppositely. A cell slot snap wall 111 is provided around the cell slot 11. The PCB installation surface 102 is provided with PCB axial positioning stages 15, dual function positioning columns 161 and dual function positioning holes 162. The dual function positioning columns 161 and the dual function positioning holes 162 have the same quantity and are disposed oppositely. A contour of the PCB installation surface 102 is provided with an edge-wrapping strip 17. The cell installation surface 101 is provided with positioning columns 18 and positioning cylinders 19. The positioning columns 18 and the positioning cylinders 19 have the same quantity and are disposed oppositely.

A top part of the hook 13 is provided with a guide angle 131. The guide angle 131 is 20°˜45°.

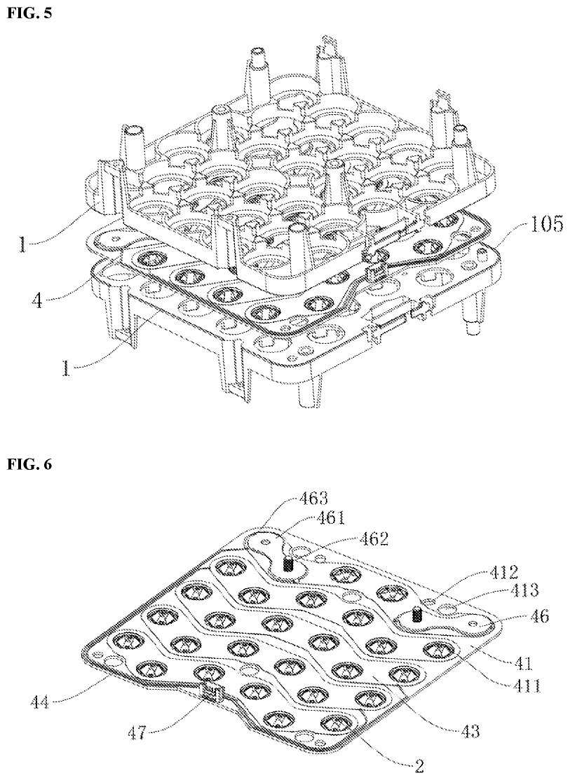

As shown in FIG. 5, the PCB busbar 4 comprises a base plate 41 and a cell connecting spring piece 2. The base plate 41 is provided with a spring piece installation hole 411, a board positioning hole 412 and a bolt through hole 413. The cell is fastened by an external force of the bolt, and the bolt through hole is configured to let the fastening bolt pass through. The base plate 1 is printed with a cell connecting circuit 43 and a cell voltage acquisition circuit 44. The cell connecting spring piece 2 is installed in the spring piece installation hole 411, the cell connecting circuit 43 is connected with the spring piece installation hole 411, two sides of the base plate 41 abut against the PCB axial positioning stage 15, and a central plane of the base plate 41 in a thickness direction aligns with a central plane of the PCB installation group 200.

The base plate 41 is provided with a lead out electrode 46, which is connected with the cell connection circuit 43. The lead out electrode 46 comprises a busbar 461 and a post 462. The post is in the form of a stud or a nut. Busbar locating buckles 463 for connecting with the base plate 41 are provided on two sides of the busbar 461. The base plate 41 is provided with a sampling connector 47, which is connected with the cell voltage acquisition circuit 44.

As shown in FIG. 8, a solder pad 45 is provided at the spring piece installation hole 411, and the cell connecting spring piece 2 is fixed at the spring piece installation hole 411 by welding with the solder pad 45.

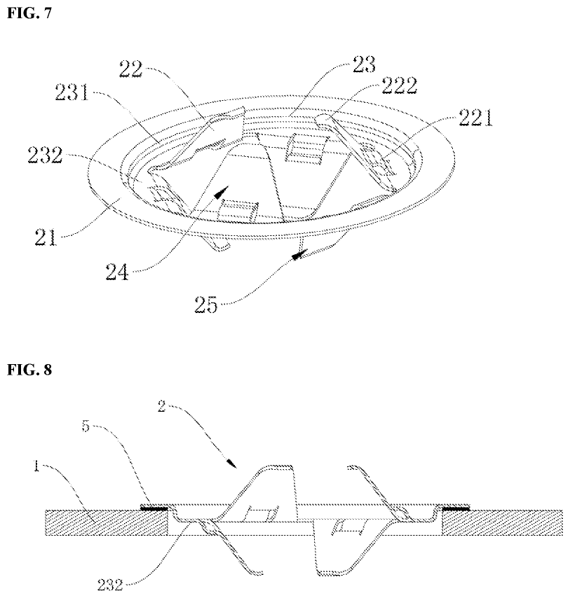

As shown in FIG. 7, the cell connecting spring piece 2 is stamped from a metal disc as a whole, and comprises: a circular solder pad 21 and a contact elastic piece 22. The circular solder pad 21 and the contact elastic piece 22 are connected through a stamping section 23. The stamping section 23 is a stamping concave structure and comprises a concave wall 231 and a stamping flat boss 232. Two ends of the concave wall 231 are respectively connected with the circular solder pad 21 and the stamping flat boss 232, and the stamping flat boss 232 is arranged in parallel with the circular solder pad 21. A base part of the contact elastic piece 22 is connected with the stamping flat boss 232, and an angle is formed between the contact elastic piece 22 and the stamping flat boss 232, and the stamping flat boss 232 aligns with a central plane of the base plate 41 in a thickness direction.

The contact elastic piece 22 is a triangle, and a bottom edge of the triangle is connected with the stamping flat boss 232. The connection part between the contact elastic piece 22 and the stamping flat boss 232 is provided with an inverted arch stiffener 221. A top part of the contact elastic piece 22 is provided with an arc contact 222. A plurality of contact elastic pieces 22 are provided on the circumference. The contact elastic pieces 22 comprise an up-warping group 24 and a down-warping group 25, and the contact elastic pieces 22 in the up-warping group 24 and the down-warping group 25 are spaced and uniformly distributed along the circumferential direction.

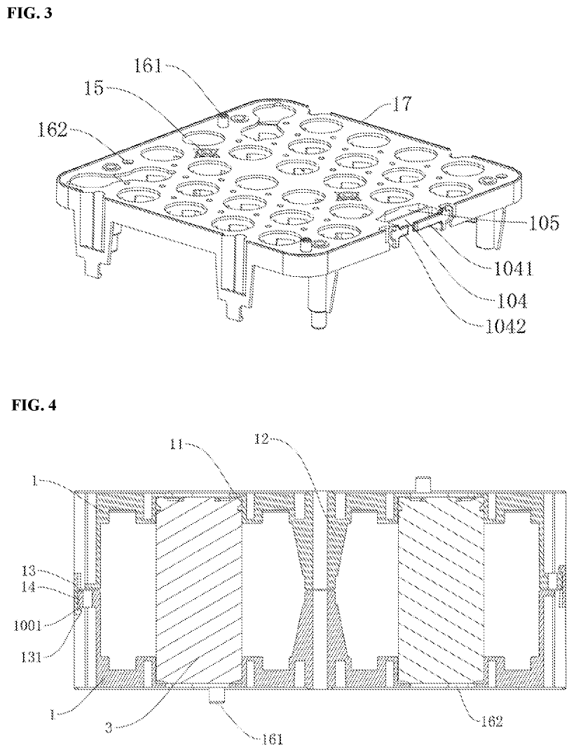

As shown in FIG. 4 and FIG. 5, the cell group 500 comprises: a cell installation group 510 and a PCB pack 520. The cell installation group 510 comprises two cell installation brackets 1 and the cells 3. The two cell installation brackets 1 in the cell installation group 510 are arranged in a central symmetry, and their cell installation surfaces 101 are opposite to each other. The cell 3 is installed between the two cell installation surfaces 101, and two ends of the cell 3 clamp in the cell slot 11. The PCB installation group 520 comprises two cell installation brackets 1 and the PCB busbar 4, the two cell installation brackets 1 in the PCB installation group 520 are symmetrically arranged in the center, and their PCB installation surfaces 102 are opposite to each other. The PCB busbar 4 is provided between the two PCB installation surfaces 102 and is positioned by the dual function positioning column 161 and the dual function positioning hole 162. The fastening long bolt 603 locks the cell installation group 510 and PCB installation group 520 via the locking through hole 104.

The quantity of cells 3 between the two adjacent locking through holes 104 is less than 6. Preferably, a gap 1001 is provided between the hook 13 and the buckle 14 of the two cell installation brackets 1 in the cell installation group 510. A wire trough 105 is provided on a side face of the cell installation bracket 1, and a long stop strip 1051 and a short stop strip 1052 are provided outside the wire trough 105. The cell installation bracket 1 is provided with a sampling port relief slot 106. The locking through hole 104 passes through the positioning column 18 and the positioning cylinder 19.

### Second Embodiment

The second embodiment differs from the first embodiment in that the metal upper pressing plate 601 is integrated with the upper end plate 300, and the metal lower pressing plate 602 is integrated with the lower end plate 400.

1. A solderless battery pack, comprising:
a battery port;
a protective plate;
an upper end plate;
a lower end plate;
cell groups arranged between the upper end plate and the lower end plate; and
a cell locking mechanism,
wherein the cell group comprises a cell installation bracket, cells and a PCB busbar, and
wherein the cell locking mechanism comprises a metal upper pressing plate, a metal lower pressing plate and a fastening long bolt that passes through the metal upper pressing plate, the metal lower pressing plate, the upper end plate, the lower end plate and the cell groups;
wherein the cell installation bracket comprises a cell installation surface, a PCB installation surface, a cell connecting hole and a locking through hole;
wherein the cell installation surface is provided with cell slots, support columns, hooks and buckles, the hooks and the buckles having a same quantity and are disposed oppositely, and a cell slot snap wall provided around the cell slot;
wherein the PCB installation surface is provided with PCB axial positioning stages, dual function positioning columns and dual function positioning holes, the dual function positioning columns and the dual function positioning holes have the same quantity and are disposed oppositely, and a contour of the PCB installation surface is provided with an edge-wrapping strip; and
wherein the cell installation surface is provided with positioning columns and positioning cylinders that have a same quantity and are disposed oppositely from each other.

2. (canceled)

3. The solderless battery pack according to claim 1, wherein:
the PCB busbar comprises a base plate and a cell connecting spring piece, the base plate is provided with a spring piece installation hole, a board positioning hole and a bolt through hole, and the base plate is printed with a cell connecting circuit and a cell voltage acquisition circuit;
the cell connecting spring piece is installed in the spring piece installation hole, the cell connecting circuit is connected with the spring piece installation hole, two sides of the base plate abut against the PCB axial positioning stage, and a central plane of the base plate in a thickness direction aligns with a central plane of the PCB installation group.

4. The solderless battery pack according to claim 3, further comprising a solder pad arranged at the spring piece installation hole, and the cell connecting spring piece is fixed at the spring piece installation hole by welding with the solder pad.

5. The solderless battery pack according to claim 4, wherein:
the cell connecting spring piece is stamped from a metal disc as a whole, and comprises: a circular solder pad and a contact elastic piece;
the circular solder pad and the contact elastic piece are connected through a stamping section, the stamping section is a stamping concave structure and comprises a concave wall and a stamping flat boss;
two ends of the concave wall are respectively connected with the circular solder pad and the stamping flat boss, and the stamping flat boss is arranged in parallel with the circular solder pad;
a base part of the contact elastic piece is connected with the stamping flat boss, and an angle is formed between the contact elastic piece and the stamping flat boss, and the stamping flat boss aligns with a central plane of the base plate in a thickness direction.

6. The solderless battery pack according to claim 1, wherein the cell group comprises: a cell installation group and a PCB installation group;
wherein the cell installation group comprises two cell installation brackets and the cells, the two cell installation brackets in the cell installation group are arranged in a central symmetry, and their cell installation surfaces are opposite to each other, the cell is installed between the two cell installation surfaces, and two ends of the cell clamp in the cell slot;
wherein the PCB installation group comprises two cell installation brackets and the PCB busbar, the two cell installation brackets in the PCB installation group are symmetrically arranged in the center, and their PCB installation surfaces are opposite to each other, and the PCB busbar is provided between the two PCB installation surfaces and is positioned by the dual function positioning column and the dual function positioning hole; and
wherein the fastening long bolt locks the cell installation group and PCB installation group via the locking through hole.

7. The solderless battery pack according to claim 6, wherein a gap is provided between the hook and the buckle of the two cell installation brackets in the cell installation group.

8. The solderless battery pack according to claim 1, further comprising a wire trough arranged on a side face of the cell installation bracket, and a long stop strip and a short stop strip are provided outside the wire trough.

9. The solderless battery pack according to claim 1, wherein a thickness of the metal upper pressing plate and the metal lower pressing plate is 1.5˜3 mm.

10. The solderless battery pack according to claim 1, wherein the metal upper pressing plate is integrated with the upper end plate, and the metal lower pressing plate is integrated with the lower end plate.
